(19) United States
(12) Patent Application Publication
(10) Pub. No.: US 2014/0195429 A1
(43) Pub. Date: Jul. 10, 2014

(54) METHOD FOR PROTECTING CARDHOLDER DATA IN A MOBILE DEVICE THAT PERFORMS SECURE PAYMENT TRANSACTIONS AND WHICH ENABLES THE MOBILE DEVICE TO FUNCTION AS A SECURE PAYMENT TERMINAL

(71) Applicant: CIRQUE CORPORATION, Salt Lake City, UT (US)

(72) Inventor: Keith L. Paulsen, Centerville, UT (US)

(73) Assignee: CIRQUE CORPORATION, Salt Lake City, UT (US)

(21) Appl. No.: 14/150,313

(22) Filed: Jan. 8, 2014

Related U.S. Application Data
(60) Provisional application No. 61/750,239, filed on Jan. 8, 2013.

(51) Int. Cl. G06Q 20/38; G06Q 20/32

(52) U.S. Cl. CPC G06Q 20/382; G06Q 20/322
USPC 705/44

(57) ABSTRACT

A system and method system and method for enabling a portable electronic appliance such as a mobile telephone or tablet computer to be able to function as a device that may store account information in order to make a secure payment, or to be able to use the portable electronic appliance as a secure payment terminal so that a credit card holder may use it to make a secure payment.

### BACKGROUND OF THE INVENTION

1. Field of the Invention

This invention relates generally to a secure transactions. More specifically, the invention is directed to a mobile device that may perform secure payments or a mobile device that may function as a secure payment terminal for financial transactions.

2. Description of Related Art

There are several designs for capacitance sensitive touch sensors. It is useful to examine the underlying technology to better understand how any capacitance sensitive touchpad may be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Using an equation that compares the magnitude of the two signals measured then performs pointing object position determination.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

The proliferation of portable electronic appliances such as mobile telephones or tablets has made it desirable to be able to use such devices in making secure payments in a financial transaction, and to function as secure terminals for others to be able to make secure payments. It would be an advantage to be able to increase security when performing any sort of financial transaction with these portable electronic appliances.

### BRIEF SUMMARY OF THE INVENTION

In a preferred embodiment, the present invention is a system and method for enabling a portable electronic appliance such as a mobile telephone or tablet computer to be able to function as a device that may store account information in order to make a secure payment, or to be able to use the portable electronic appliance as a secure payment terminal so that a credit card holder may use it to make a secure payment.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

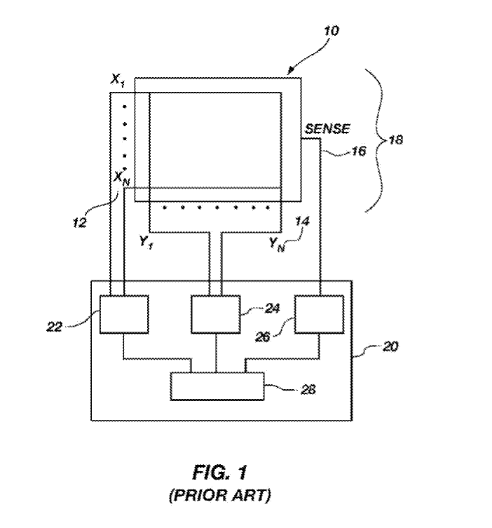

FIG. 2 is a diagram of a first embodiment for making a mobile payment.

FIG. 3 is a diagram of a second embodiment for making a mobile payment.

FIG. 4 is a diagram of a third embodiment for making a mobile payment.

FIG. 5 is a diagram of a fourth embodiment for making a mobile payment.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may be used interchangeably with “capacitive touch sensor”, “touch panel”, “touchpad” and “touch screen”. In addition, the term “portable electronic appliance” may be used interchangeably with the “mobile telephone”, “smart phone” and “tablet computer”.

The present invention is directed to the concept of using a portable electronic appliance that is also a consumer device into either a device that is capable of making a secure payment by emulating a credit card, or a device that is capable of receiving credit card information and receiving payment.

It should be understood that use of the term “credit card” may be used interchangeably with “debit card”, “ATM card”, “smart card” or any other card that stores information that enables a credit, debit or cash transaction to take place.

Consider a point-of-sale (POS) terminal. A consumer may use a smart card that functions as a credit card to make a payment by bringing the smart card close enough to a smart card reader that is part of the POS terminal. The POS terminal reads account information from the smart card and then communicates with financial institutions in order to perform the financial transaction. This process may vary in details but is essentially the transaction that is going to be modified by the present invention.

The present invention is directed to making a consumer device, such as a portable electronic appliance such as a smart phone, perform both sides of a typical transaction. In other words, a first smart phone may function as the smart card, and a second smart phone may function as the POS or mobile terminal. This document may use the term “mobile payment” to refer to the smart phone functioning as a smart card for making a payment, and may use the term “MPOS” for referring to a mobile point-of-sale device wherein the smart phone may be functioning as a mobile point-of-sale terminal.

Using mobile devices such as a smart phone to make a mobile payment and to function as a mobile terminal for receiving that payment may add significant value to the field of micro-merchants.

An aspect of the present invention that enables mobile payments and mobile terminal or MPOS functions is the use of a secure element. A secure element includes at least four different embodiments, but should not be considered as limited to these four. These four embodiments of a secure element include a Subscriber Identity Module (SIM) which is also known as a Universal Integrated Circuit Card (UICC). The SIM/UICC may be a SIM or memory card that may be disposed inside the smart phone. Another embodiment may be an embedded SIM card that may be soldered into the smart phone. Another embodiment may be a microSD card that fits into a microSD slot in the smart phone. Another embodiment may be a secure CPU in which the secure element is embedded inside a CPU of the smart phone. The secure element therefore provides a secure memory for at least storing financial data from a credit card. The secure element may also provide other features such as performing encryption and creating a token.

The present invention uses any form of the secure elements described, or any other form factor for the secure element as long as the secure element may be disposed inside or made a part of a mobile consumer device in a secure manner, and then use the secure element to enable the mobile device to perform mobile payments or to function as a mobile terminal.

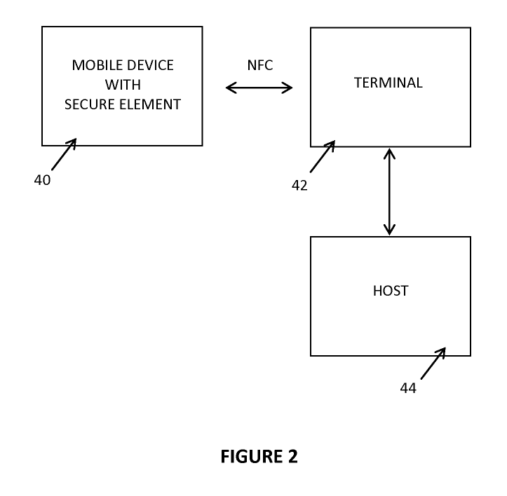

FIG. 2 is a first embodiment of the invention that is directed to making a payment or a mobile payment using a smart phone or other similar consumer device. The smart phone 40 may include a near field communication antenna that enables communication to another device that may also communicate using near field communication technology. For example, one device may include an NFC transmitter and the other device may include an NFC receiver, or one or more devices may include an NFC transceiver for both sending and receiving NFC data.

The smart phone 40 may be used to perform a financial transaction by storing financial account information. This information may be stored in a manner that is similar to a smart card. The smart phone may either store the account information in a separate and/or secure memory that is dedicated to that purpose, or store it in memory that may be used by the smart phone for other functions as well.

The smart phone may also include a near field communication antenna that may be used to transmit financial account information to a secure payment terminal.

In FIG. 2, the smart phone 40 may approach a terminal 42. The smart phone 40 and the terminal 42 may communicate using near field communication technology using a near field communication antenna on each device. The terminal 42 may receive data stored in a secure element from the smart phone 40 and send it to a financial institution that may be referred to as a host 44.

An important aspect of the first embodiment shown in FIG. 2 is the use of the secure element data that is stored in the smart phone 40.

FIG. 2 is also directed to a financial transaction, but instead of having the smart phone 40 function as a single credit card, the smart phone may function as a digital wallet. A digital wallet may be defined as a secure device for storing a plurality of account numbers of different credit cards, debit cards, ATM card or smart cards for use with different hosts. The smart phone may also include authentication credentials for a secure element. The authentication credentials may be downloaded from the host to the secure element of the smart phone.

For example, consider the situation where a user desires to make an online purchase. The secure element may be in a mobile device (mobile phone, laptop, etc.) which may be used to make online purchases. The secure element may contain the credit card information such as the account number that is necessary to perform the transaction.

FIG. 2 is therefore also directed to the aspect of using the digital wallet. The digital wallet may be stored in the secure element. Thus, because credit card information may be stored in the digital wallet, and the digital wallet may be stored in the secure element, a financial transaction such as the online purchase may be performed without having to pull out and use the information on a physical credit card. The transaction may be faster and may also be performed without the credit card having to be physically present.

Another example of the use of a digital wallet is making a payment in a situation that presently requires a customer to physically hand a credit card to a cashier. For example, consider a consumer who is in a drive-thru lane at a fast food restaurant. The customer makes an order. To pay for the order, the consumer may scan a QR code provided by the restaurant by using a smart phone while in the drive-thru lane. The QR code may identify the restaurant to the smart phone. This information is used to enable the smart phone to locate a transaction that is waiting to be completed with the smart phone by providing the credit card information. Payment may then be made through the mobile device without the need to hand over a credit card to the cashier. One advantage of this system is a faster payment transaction. Another advantage may be due to not having to give a credit card to a cashier, thereby avoiding having to reveal a credit card number, a signature or a security code on the back of the credit card.

This is an example only and should not be considered as limiting to other scenarios or embodiments that may be performed. The consumer may be given access to the pending charges by scanning a QR code and allowing the mobile device to perform the transaction using a non-secure connection to the Internet.

Another example is making a payment to a parking meter in order to park a vehicle on a street. The parking meter may include a coin slot as well as identification information so that the particular meter being used may be associated with the financial transaction that is going to be executed. The parking meter may also have a QR code that may be scanned. For example, using the present invention, the driver may scan the QR code that enables a payment to be made without having to have coins for a parking meter or having to take a credit card out of a pocket if the parking meter includes swipe or NFC input.

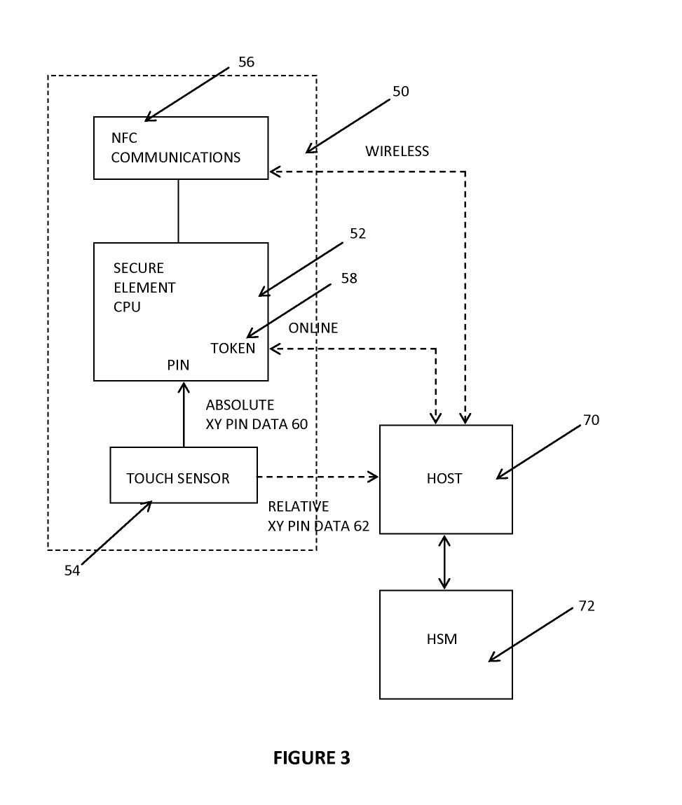

FIG. 3 is directed to a second embodiment that may be different from FIG. 2 because it stores a secure element in a CPU (a secure element CPU) that is not part of any other functions of the mobile device. In FIG. 3, the mobile device, which may be a smart phone 50, includes a secure element CPU 52, a touch sensor 54 and a near field communication system 56. The secure element CPU 52 may take on all the functions of a secure payment terminal, which includes the concept of a mobile payment terminal.

This second embodiment may enable the secure element CPU 52 to communicate directly with a near field communication antenna of the near field communication system 56 in an active mode instead of as a TAG emulator.

This embodiment also includes the concept of using a token 58 or tokenizing in the secure element CPU 52 in a consumer device. While the process of tokenizing is known, tokenizing in a consumer device may be unique and enables the consumer mobile device to function as a secure mobile terminal.

It should also be understood that this embodiment works with “Chip and PIN”. Chip and PIN is a brand name adopted by the banking industries in the United Kingdom and Ireland for the rollout of an EMV smart card payment system for credit, debit and ATM cards. EMV is a global standard for credit and debit payment cards based on chip card technology, taking its name from the card schemes Europay, MasterCard, and Visa that developed it. The word “Chip” refers to a computer chip embedded in the smartcard, and the word PIN refers to a personal identification number that must be supplied by the customer. In the United States, financial transactions with a credit card are typically made using a signature, whereas the European model uses PINs. This embodiment enables the use of PINs in the mobile terminal.

FIG. 3 shows that in this embodiment, a PIN 60 may be input directly from the touch sensor 54 into the secure element CPU 52 without going through the Operating System. Thus the PIN 60 is transferred in a secure manner from the touch sensor 54 to the secure element CPU 54. This step of direct and secure input may be important to this and other embodiments because the present invention is able to unlock the secure element CPU 52 when performing a mobile payment. This step also enables a purchaser to be able to input a PIN into a consumer device in a trusted way. In other words, the present invention enables the input of a PIN into a mobile terminal (in this case the smart phone 50) a secure process.

In order to ensure the integrity of the transaction, inputting a secure PIN may be critical. This process is secure when used for an offline transaction, and by inputting the PIN into the secure element CPU 52 where it may be encrypted, it may be used in an online transaction as well.

The PIN data is sent to a Host 70 as described previously in order to complete a financial transaction. A new element in FIG. 3 is the detail of a Host Security Module (HSM) 72 which may be part of the Host 70 or it may be separate as shown,

The method of transmitting the encrypted token to the host may be through an online connection such as a wired connection, a Wi-Fi connection, a cellular connection or a wired connection. The method of transmitting may also be via the near field communication system, which is another wireless communication system.

The method of entering a PIN securely into the mobile device 50 either for performing a mobile payment or in order to function as a mobile terminal may be the same. In other words, whether the mobile device 50 is functioning as a digital wallet or as a mobile terminal, the methods of entering the PIN data are identical.

Consider the touch sensor 54 to be a touchpad or a touch screen that may be used for securely entering PIN data, or providing secure input that is not accessible by the operating system of the mobile device 50. The absolute XY position of a finger may be transferred from the touch sensor 54 to the secure element CPU 52 directly and within the smart phone 50. This is referred to as absolute XY PIN data 60 that may not have to be hidden because it goes directly to the secure element CPU 52 and bypasses the Operation System. By bypassing the Operating System, the data may be secure and there may be no need to encrypt or otherwise hide the pin information.

It is noted that PIN data may be obtained directly from absolute XY PIN data 60 because the touch sensor 54 may have positions that always correspond associated PIN numbers on a displayed keypad. In contrast, relative XY position data 62 may be transferred to the Host 70 in order to hide the absolute XY position data. The relative XY position data 62 may be decoded to determine an actual PIN number. For example, the token 58 may be used to extract a PIN number for the Host 70. This enables a consumer device to securely perform Chip and PIN.

A secure element may previously only have had access to the Host and/or the NFC. However, the present invention takes advantage of the secure element CPU 52 now being able to receive input, including PIN data, from multiple sources. Thus the present invention enables the touch sensor 54 to communicate with the secure element CPU 52 as if it is the Host 70. This enables secure communication with the secure element CPU 52 by allowing direct input of PIN data. The significance of this ability may be in the fact that this process of inputting PIN data to the secure element CPU 52 is taking place in a consumer device that is in other respects not a secure device.

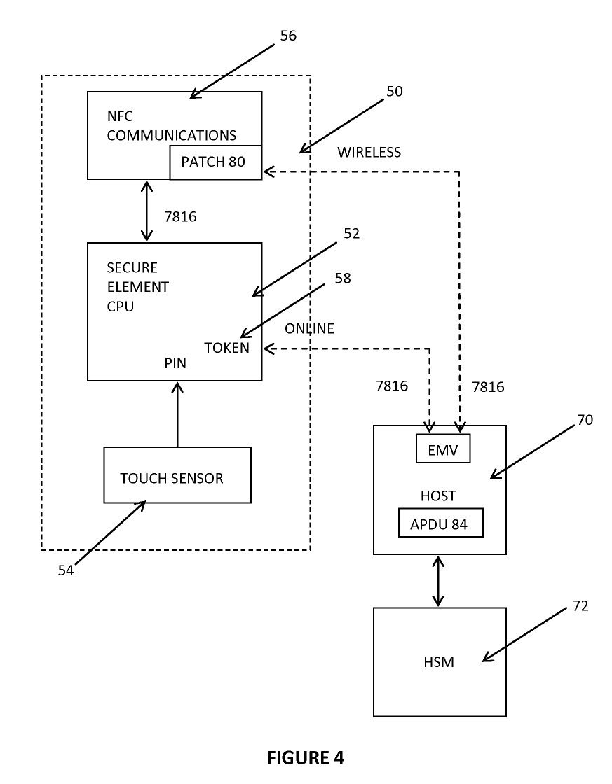

A third embodiment of the present invention is shown in FIG. 4. FIG. 4 is a block diagram of a system that is very similar to the system shown in FIG. 3. However, the system is now modified in important ways.

First, FIG. 4 show that the near field communication system 56 includes an area of the near field communication system 56 that may be modified through software. Therefore, software of the near field communication system 56 may modified through application of a software patch 80. For example, the near field communication system 56 may include an EEPROM that may store the software patch 80.

In order to prevent tampering, it may also be possible to modify the near field communication system 56 by including a software patch in the smart phone 50. The software patch 80 in the EEPROM may control communications or the software patch stored in the secure element CPU 52 may control. Furthermore, the integrity of the software patch 80 may then be confirmed by comparing a software patch stored in the secure element CPU 52. Accordingly, the present embodiment provides more than one location to store the software patch 80, provides a means for verifying the integrity of the software patch, and provides that one or the other software patch 80 may override the other and control communication.

Another modification shown in FIG. 4 is that the Host 70 may include the EMV system 82 for processing card data. The EMV 82, the Host 70 or another system may also include an Application Data Unit (APDU) 84 that may request the credit card account number of the card being used for a financial transaction. The request for the account number would be sent to the near field communication system 56 which would request the account number from a credit card. The near field communication system 56 may then wirelessly or without making contact request the account number from a physical card such as a smart card, and then transmit the account information to the Host 70.

One function of the software patch 80 may be to intercept the request for an account number because it could be malware or another device making that request. Instead, the request may be intercepted by the software patch 80 and routed to the secure element CPU 52. The secure element CPU may then route the request to the smart phone 50, a smart card or mobile payment device.

The advantage of having the request for the account number come from the secure element CPU 52 is that the account number will then be returned to the secure element CPU 52 before it is sent on. Advantageously, the secure element CPU 52 is thus able to secure the safety of the account number. For example, the secure element CPU 52 may encrypt the account number before transmitting it to the APDU 84 as a token.

Another advantage of using the secure element CPU 52 to transmit the encrypted account number is that the encrypted account number may now be modified by any convenient means, such as performing a mod 9 process on it to make the number appear as an account number with the expected number of digits. This encrypted number would then be passed down to the Host 70. If the Host 70 was actually malware trying to obtain an account number for malicious purposes, the information that would be passed to it is not an actual account number but a token, and the real account number is therefore safe. The Host 70 may then send the token to the Host Security Module 72 of the financial institution for decrypting in order to obtain the real account number.

It should be understood that the consumer also entered a PIN that needed to be transmitted along with the account number. Because the PIN and the account number are both sent to the secure element CPU 52, they may be encrypted together and transmitted in the same Token 58, or the PIN may be encrypted and sent as a separate token. It is preferred that the PIN be encrypted with the account information and be sent to the Host Security Module 72 as a single token.

The path and the process described in FIG. 4 may be referred to as a Secure Loop. The Secure Loop is given its name because the Host 70 never has to be trusted. In other words, any request that comes from the Host 70 for a PIN or an account number is treated as if the request comes from any unsecured source. Accordingly, all information sent to the Host 70 is always encrypted in a token that only the real Host 70 will be able to use and extract the correct information.

Another feature shown in FIG. 4 is that the communication protocol used between the smart phone 50 and the Host 70 and even inside the smart phone 50 between the near field communication system 56 and the secure element CPU 52 may be assumed to use ISO 7816. ISO 7816 is an international standard related to electronic identification cards with contacts, especially smart cards, managed jointly by the International Organization for Standardization (ISO) and the International Electrotechnical Commission (IEC)

The Secure Loop of the present invention may be summarized as the process of intercepting the request for account information, requesting the account information and sending it to the secure element CPU 52 where it may be encrypted and tokenized with the PIN data, and then sent to the Host Security Module 72 through the Host 70 which may or may not be an intended Host. Because the Host 70 cannot decrypt the tokenized information, it is secure. The decryption is performed by the Host Security Module 72. If the Host 70 is actually a hacker or malware, no unencrypted account information or PIN data is sent to the Host, thereby ensuring the security of all data that is sent.

It should also be noted that EMV parsing may be performed by the Host 70. This step may be beneficial because it is a relatively long process or computer intensive, and the Host 70 will have the resources to devote to the process.

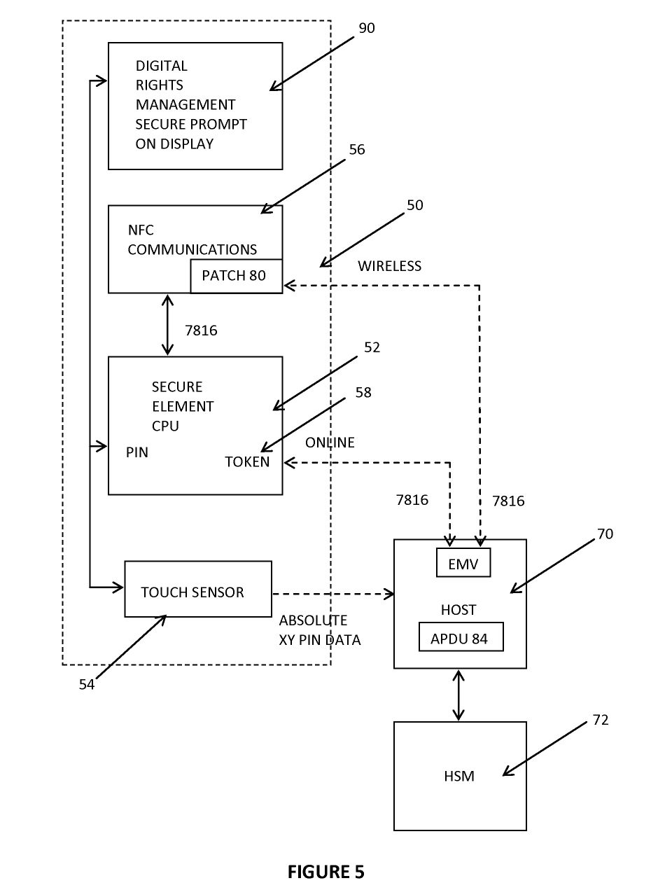

FIG. 5 is directed to a fourth embodiment that includes elements of mobile payment. This embodiment is directed to the issue of being able to authenticate a customer. For example, a digital wallet application in the smart phone 50 may try to authenticate the owner of a credit card by requesting a PIN number. The problem with security is that the PIN number is being entered on an unsecure smart phone 50 or unsecure touch sensor 54 in the smart phone. For this reason, the financial transactions that may be allowed by such a digital wallet may only be low cost transactions in order to limit fraud.

While the previous embodiments were concerned with the entering of account information through direct contact or contactless means through the near field communication system 56, this embodiment is concerned with the entry of touch data through the touch sensor 54. Thus, the account number may be entered once by reading the credit card through wireless transmission and storing the account number in the secure element CPU 52 in a one-time pairing of the account number with a credential. Thus, the secure element CPU 52 will proxy or broker the transactions after that initial pairing.

The touch sensor 54 is again used to securely transmit PIN data to the secure element CPU 52, bypassing the Host 70. This is accomplished by directed transmitting absolute XY position data.

However, a new feature of this embodiment in FIG. 5 may be the use of Digital Rights Management (DRM) through a Digital Rights Management module 90 that may be used, for example, to render proprietary blu-ray video on a mobile device.

It is envisioned that in the present embodiment, the Digital Rights Management module 90 may be used to generate a secure prompt that is comprised of a PIN entry screen that the Operating System cannot access. By sending the secure prompt through the secure element CPU 52, the secure prompt, which may contain a keypad for entering the PIN, is encrypted. While a display screen is typically operated by an Operating System, a secure display or a secure prompt on an unsecure display would not be seen by the Operating System because the secure prompt portion may be encrypted. Thus the secure prompt on the screen is now a protected prompt. The information typed on the screen is thus sent directly to the secure element CPU 52, entirely bypassing the Operating System.

In an alternative embodiment, the touch sensor 54 may encrypt the PIN data using the touch sensor circuitry, and then pass the encrypted PIN data through the Operating System.

The Digital Rights Management module 90 method does not need to be used for protecting the PIN data if the touch sensor 54 is performing its own encryption. However, both methods could also be used at the same time.

It should be understood that the actual touch locations representing PIN data may be delivered to the Operating System, but if the PIN pad is being scrambled by the Digital Rights Management module 90, then that information is useless. In other words, if ten digits 0 through 9 are shown, but they are out of order and the order is only know to the Digital Rights Management module 90, then the unencrypted position data can be sent through the Operating System because it does not know the value of the digits where the finger made contact.

An advantage of the user seeing a scrambled PIN input screen is that the user understands that while the Operating System of the device knows where the user is touching the screen to input the PIN numbers, that information is useless because the numbers are out of order, and therefore the information is useless to the Operating System. Thus, this acts as a feedback system to the user. The correct order of the PIN numbers may only be known to the Digital Rights Management module 90, the touch sensor 54, the secure element CPU 52, or a combination of these components, but not the Operating System, so the transaction is secure.

In another embodiment, the secure element CPU 52 might send a picture to the Digital Rights Management module 90 to be displayed with the prompt. This picture may provide assurance to the user that the prompt being generated by the Digital Rights Management module 90 is secure because it came from the secure element CPU 52. Likewise, the Host Security Module 72 could also send an encrypted picture to be displayed by the Digital Rights Management module 90 in the secure prompt.

One aspect of the invention is that while the mobile device may act as a digital wallet which simply stored financial information such as credit card account numbers, it may also function as a mobile terminal or MPOS at the same time, or it may function only as the mobile terminal and not retain the credit card account information.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A system for making a secure payment using a secure element in a mobile device, said system comprised of:
a mobile device;
a secure element within the mobile device for securely storing financial data;
a touch sensor for providing secure input to the secure element that is not accessible by an operating system of the mobile device; and
a means for communicating with a host that processes a financial transaction.

2. The system as defined in claim 1 wherein the secure element is further comprised of a secure element CPU that may process financial information stored therein.

3. The system as defined in claim 1 wherein the means for communicating is further comprised of a near field communication system that is coupled to the mobile device to thereby provide wireless communication.

4. A method for making a secure payment using a secure element in a mobile device, said method comprised of:
1) providing a mobile device, a secure element within the mobile device for securely storing financial data, a touch sensor for providing secure input to the secure element that is not accessible by an operating system of the mobile device, and a means for communicating with a host that processes a financial transaction;
2) receiving a personal identification number on the touch sensor;
3) transmitting the personal identification number to the secure element in a secure manner such that the operating system does not see the personal identification number;
4) creating a token that combines at least the personal identification number and a credit card account number; and
5) transmitting the token to the host.

5. The method as defined in claim 4 wherein the method further comprises:
1) providing a secure element CPU as the secure element in order to process data to create an encrypted token; and
2) encrypting the token.

6. The method as defined in claim 5 wherein the method further comprises:
1) transmitting the encrypted token from the host to a Host Security Module;
2) decrypting the token in the Host Security Module to obtain at least the personal identification number and the credit card account number; and
3) transmitting the decrypted personal identification number and the credit card account number to the host and completing the financial transaction.

7. The method as defined in claim 4 wherein the method further comprises:
1) providing a near field communication system for wireless communication;
2) receiving the credit card account information from the credit card using the near field communication system; and
3) transmitting the credit card account information from the near field communication system to the secure element.

8. The method as defined in claim 7 wherein the method further comprises transmitting the encrypted token from the host to the Host Security Module using an online connection or a near field communication system connection.

9. The method as defined in claim 8 wherein the method further comprises providing a software patch in the near field communication system that may be used to intercept a request for the credit card account information from the host.

10. The method as defined in claim 9 wherein the method further comprises storing the software patch in an EEPROM so that it may be updated as needed.

11. The method as defined in claim 10 wherein the method further comprises storing the software patch in memory of the secure element CPU to thereby verify the integrity of the software patch that is stored in the near field communication system.

12. The method as defined in claim 11 wherein the method further comprises providing a secure prompt in the mobile device that prevents access to data input to the secure prompt from an operating system of the mobile device.

13. The method as defined in claim 12 wherein the method further comprises using a digital rights management module to create the secure prompt on a display of the mobile device.

14. The method as defined in claim 13 wherein the method further comprises enabling the touch sensor to input data to the secure prompt created by the digital rights management module to thereby prevent the operation system from receiving input from the touch sensor that is input to the secure prompt.

15. The method as defined in claim 4 wherein the secure element is selected from the group of secure elements comprised of a subscriber identity module (SIM), a universal integrated circuit card (UICC), a SIM card, a microSD slot and a secure element CPU.
